(19) United States
(12) Patent Application Publication
(10) Pub. No.: US 2026/0349514 A1
(43) Pub. Date: Nov. 5, 2026

(54) STIMULATION DEVICE AND ELECTRONIC DEVICE

(71) Applicant: MINEBEA MITSUMI Inc., Kitasaku-gun, Nagano (JP)

(72) Inventors: Kodai KAMEOKA, Kitasaku-gun, Nagano (JP); Yuta TOKUDA, Kitasaku-gun, Nagano (JP)

(21) Appl. No.: 19/485,860

(22) PCT Filed: May 16, 2024
(86) PCT No.: PCT/JP2024/018083

§ 371 Date: Nov. 19, 2025

(30) Foreign Application Priority Data
Jun. 2, 2023 (JP) 2023-091724
Jun. 2, 2023 (JP) 2023-091725

(51) Int. Cl. G06F 3/01; G06F 3/03; H02K 33/02

(52) U.S. Cl. CPC G06F 3/016; G06F 3/03; H02K 33/02

(57) ABSTRACT

A stimulation device includes a casing including an opening and a space connected to an outside via the opening, a diaphragm, a magnetic body supported by the diaphragm, a magnetic body covered with the diaphragm, and a coil. The fluid is discharged from a space to the outside via the opening.

### TECHNICAL FIELD

The present invention relates to a stimulation device and an electronic device.

### BACKGROUND ART

Patent Document 1 discloses an electromagnetic drive device used for a valve, for example. The electromagnetic drive device includes an inflow channel and a plurality of outflow channels. A valve gate attached to a magnet is displaced by magnetic interaction between a coil and the magnet disposed in a core. The displacement of the valve gate switches the communication between the inflow channel and the outflow channel.

For example, Patent Document 2 discloses a display device displaying an object in a space as a non-contact user interface. In this display device, a sensor detects that, for example, a finger of a user is disposed at a position of the object displayed in the space. Based on the detection by the sensor, a sound pressure is generated by an ultrasonic wave from an ultrasonic element array for the position of the finger. In this way, a pseudo tactile sense is given to the finger of the user.

### CITATION LIST

### Patent Literature

Patent Document 1: JP S58-46861 A

Patent Document 2: JP 2022-113411 A

### SUMMARY OF INVENTION

### Technical Problem

In the electromagnetic drive device of Patent Document 1, the intake air and the exhaust air are directed in different directions, and thus there is a possibility that the application of the electromagnetic drive device is limited. Since a guide ring for guiding the displacement of the magnet including the valve gate is required, the configuration of the device itself becomes complicated. On the other hand, for example, a stimulation device providing a pseudo tactile sense, that is, a stimulus to a finger is known.

It is difficult to reduce the size of the display device including the ultrasonic element array of Patent Document 2 due to the nature of generating ultrasonic waves. On the other hand, the non-contact user interface is utilized for various applications, and the size reduction of the non-contact user interface is required.

An object of the present invention is to provide a stimulation device capable of providing stimulation with a simple configuration.

An object of the present invention is to provide an electronic device capable of realizing the size reduction with a simple configuration.

### Solution to Problem

A stimulation device according to an aspect of the present invention includes a casing including an opening and a space connected to an outside via the opening; a diaphragm; a magnetic body supported by the diaphragm; a magnetic body covered with the diaphragm; and a coil, wherein a fluid is discharged from the space to the outside via the opening.

An electronic device according to an aspect of the present invention includes a display device including a side surface; a sensor; and a drive device, wherein the display device displays an object at a space adjacent to the side surface, an opening is formed at the side surface of the display device, and the drive device discharges a fluid from the opening toward the object.

### BRIEF DESCRIPTION OF DRAWINGS

FIG. 1 is a perspective view schematically illustrating a structure of an electronic device 1 according to a specific example including a stimulation device of the present invention.

FIG. 2 is a cross-sectional view of the electronic device 1 taken along line 2-2 in FIG. 1.

FIG. 3 is a partial cross-sectional view of a display unit 14 taken along line 3-3 in FIG. 1.

FIG. 4 is a perspective view schematically illustrating a structure of a drive device 30 according to an embodiment.

FIG. 5 is a cross-sectional view taken along line 5-5 in FIG. 4.

FIG. 6 is a cross-sectional view taken along line 6-6 in FIG. 4.

FIG. 7 is a cross-sectional view of the drive device 30 when a current is supplied to a coil 40, corresponding to FIG. 6.

FIG. 8 is a cross-sectional view of the drive device 30 when a current is supplied to the coil 40, corresponding to FIG. 5.

FIG. 9 is a perspective view corresponding to FIG. 1 and schematically illustrating a structure of an electronic device 1 according to a variation.

FIG. 10 is a perspective view corresponding to FIG. 1 and schematically illustrating a structure of an electronic device 1 according to another embodiment.

### DESCRIPTION OF EMBODIMENTS

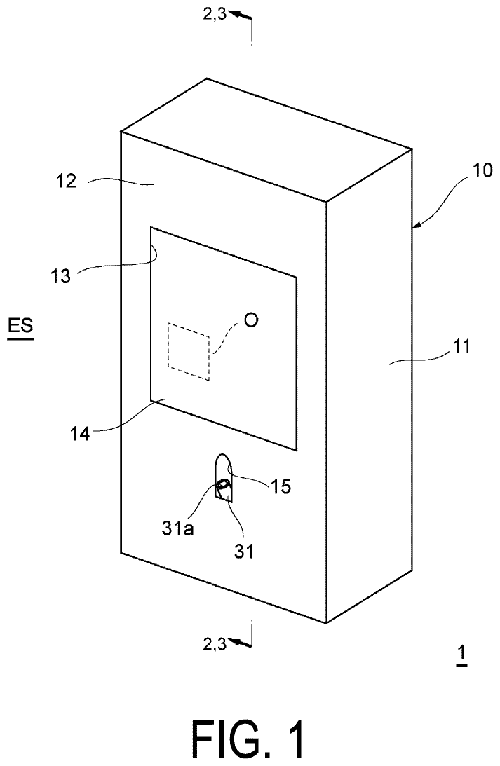

An embodiment of the present invention will be described below with reference to the accompanying drawings. FIG. 1 is a perspective view schematically illustrating a structure of an electronic device 1 according to a specific example including a stimulation device of the present invention. The electronic device 1 provides a non-contact user interface capable of detecting an input by a finger of a user, for example. The electronic device 1 can be applied to various non-contact user interface applications such as an opening/closing button of a door for entering and exiting a restroom or a room, an operation button of an elevator, and an on/off button of a medical device or an electronic device. However, the application of the electronic device 1 is not limited to the above.

The electronic device 1 includes a display device 10. The display device 10 includes a housing 11 having, for example, a box shape. In this example, the housing 11 has, for example, a vertically long rectangular parallelepiped outer shape. A side surface 12 is defined at the front surface of the housing 11. The side surface 12 is defined by, for example, a plane along a vertical surface. The display device 10 defines a first opening 13 having, for example, a rectangular shape and open at the side surface 12. The first opening 13 is defined to have, for example, a rectangular shape. A display unit 14 is disposed in the first opening 13. As described later, the display unit 14 can display a user-visible object O at a space (hereinafter referred to as an “exterior space” or an “outside”) ES adjacent to the side surface 12 by emitting light from inside the first opening 13. The object O is an aerial image. That is, the display device 10 is a so-called spatial display device.

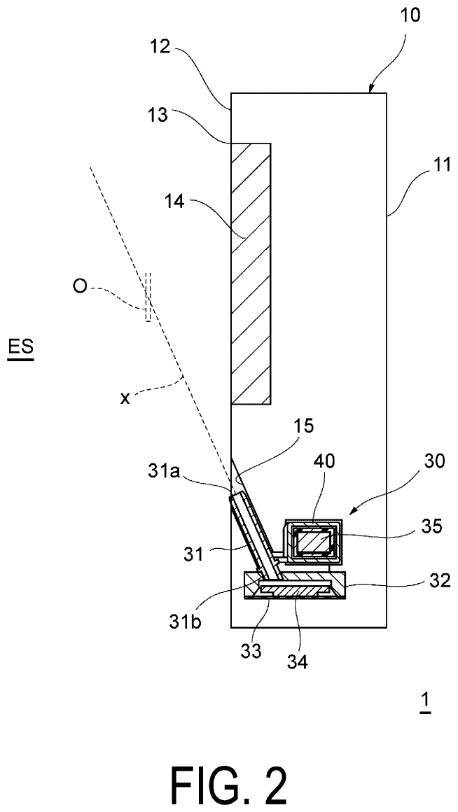

FIG. 2 is a cross-sectional view of the electronic device 1 taken along line 2-2 in FIG. 1. Referring to FIGS. 1 and 2 together, the electronic device 1 includes a drive device 30 incorporated in the housing 11 of the display device 10. In this example, the drive device 30 is disposed below the display unit 14 in the housing 11. The drive device 30 includes a single nozzle 31 disposed in a second opening 15 formed at the side surface 12 of the housing 11. The nozzle 31 is formed, for example, in a cylindrical shape. The second opening 15 is defined to have, for example, a circular shape. As is clear from FIG. 2, the object O is displayed in the exterior space ES, for example, at a position separated from the display unit 14 by a predetermined distance in the horizontal direction.

The central axis line x of the nozzle 31 passes through the position of the object O or the vicinity of the object O. That is, an opening 31a at the tip of the nozzle 31 is disposed oriented to the object O. The drive device 30 can discharge the fluid from the opening 31a of the nozzle 31 toward the object O of the exterior space ES along the central axis line x. The drive device 30 is, for example, a pump. As described later, when the user places his/her finger at the position of the object O or in the vicinity of the object O, a pseudo tactile sense, that is, a stimulation is applied to the finger of the user by the fluid discharged from the opening 31a of the nozzle 31 to the exterior space ES. That is, the drive device 30 is a so-called aerial tactile device, and is a stimulation device according to the present invention. Note that the finger of the user forms a “target” according to the present invention.

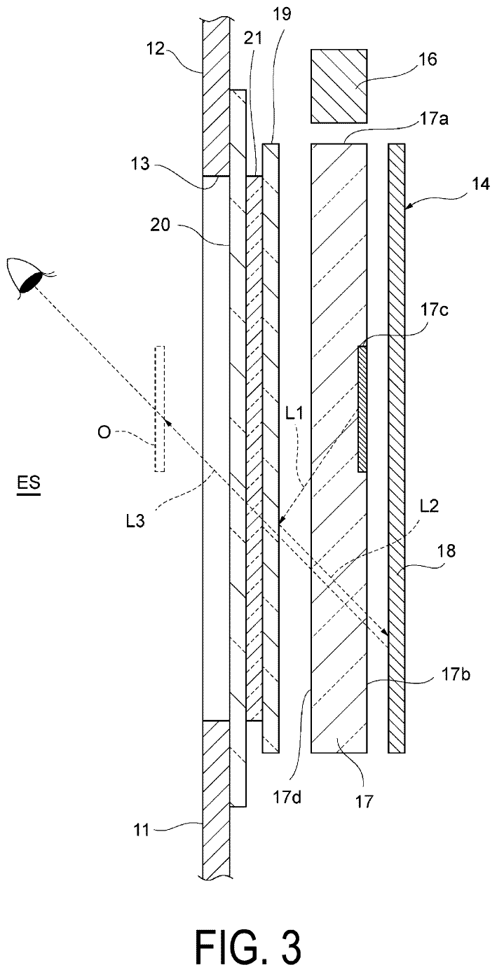

FIG. 3 is a partial cross-sectional view of the display unit 14 taken along line 3-3 in FIG. 1. As illustrated in FIG. 3, the display unit 14 includes a light source 16 and a light guide plate 17 disposed below and adjacent to the light source 16. The light guide plate 17 is set to a size covering the first opening 13 of the housing 11. The light source 16 is a linear light source emitting light in the longitudinal direction of the side surface (hereinafter, referred to as “light incident side surface”) 17a of the light guide plate 17 opposed to the light source 16. Specifically, the light source 16 includes a pair of light emitting diodes (LEDs, not illustrated) disposed at both ends of the light source 16 in the longitudinal direction, and a light bar (not illustrated) disposed between the pair of light emitting diodes. The light emitted from the light emitting diodes is incident on the light incident side surface 17a of the light guide plate 17 by the light bar.

The light guide plate 17 is formed of a transparent resin material such as polycarbonate or acrylic resin, for example. A part (hereinafter, referred to as a “refraction part”) 17c where light is refracted is formed at one side (hereinafter, referred to as a “non-display surface side”) 17b of the light guide plate 17 facing away from the side surface 12. The refraction part 17c is formed by, for example, a prism or the like. The light guide plate 17 guides the light incident from the light incident side surface 17a to the refraction part 17c, and the refraction part 17c refracts the light to the other side (hereinafter, referred to as “display surface side”) 17d of the light guide plate 17 opposed to the side surface 12. In this example, the refraction part 17c can refract light incident on the light guide plate 17 downward from the light source 16 above, obliquely downward to the display surface side 17d. Note that the shape of the prism of the refraction part 17c coincides with the shape of the object O displayed at the exterior space ES adjacent to the side surface 12.

The display unit 14 includes a retroreflective sheet 18 disposed adjacent to the light guide plate 17 on the non-display surface side 17b. The retroreflective sheet 18 is a sheet having a property of emitting incident light along the same path. That is, the incident angle of light incident on the retroreflective sheet 18 is the same as the emission angle of light emitted from the retroreflective sheet 18. The retroreflective sheet 18 is a sheet with transparent minute glass beads or the like being disposed at the surface without gaps. Note that, instead of the glass beads, a so-called corner cube may be used. The corner cube is obtained by using inner surfaces of a cube at the apex formed by combining three flat plates having a property of reflecting light.

The display unit 14 includes a half mirror 19 disposed adjacent to the light guide plate 17 on the display surface side 17d, and a top cover 20 disposed adjacent to the outside of the half mirror 19. The half mirror 19 is, for example, an optical element. The half mirror 19 has a property of reflecting about a half of incident light, while transmitting about the other half of the incident light. The top cover 20 is a cover for protecting the half mirror 19. The top cover 20 is formed of, for example, a transparent resin material. By reducing the transmittance of the top cover 20, the inside of the display unit 14 can be less visible from the exterior space ES. As a result, only the object O can be made easy to see.

The electronic device 1 includes a sensor 21. In this example, the sensor 21 is disposed between the half mirror 19 and the top cover 20. The sensor 21 is, for example, a capacitance type sensor. When a target enters an electric field of an electrode (not illustrated) of the sensor 21, the charge amount of the electrode changes. The entry of the target into the electric field can be detected by the change in the charge amount. In this way, the sensor 21 can detect the finger of the user entering the position of the object O or the vicinity of the object O. Note that, although the present embodiment has described an example including the sensor 21 in the display unit 14, the sensor 21 may be incorporated in another position of the display device 10. As the sensor 21, for example, a proximity sensor using infrared rays, a sensor using an imaging element, or the like may be used.

In the display unit 14, light emitted from the light source 16 enters the light guide plate 17 from the light incident side surface 17a. The incident light is emitted by the refraction part 17c to the display surface side 17d along a path L1. About a half of the emitted light is reflected by the half mirror 19, and passes through the light guide plate 17 along a path L2 to travel toward the retroreflective sheet 18. Light along the path L2 is reflected by the retroreflective sheet 18 at the same exit angle as the incident angle. The reflected light returns to the half mirror 19 along a path L3, and about a half of the light passes through the half mirror 19. Thus transmitted light generates an aerial display of the object O in the exterior space ES adjacent to the side surface 12. The user can visually recognize the object O from a predetermined position.

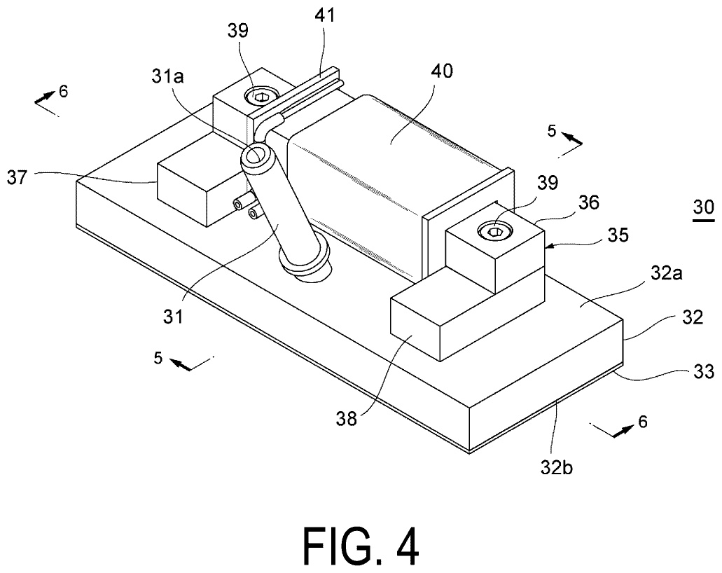

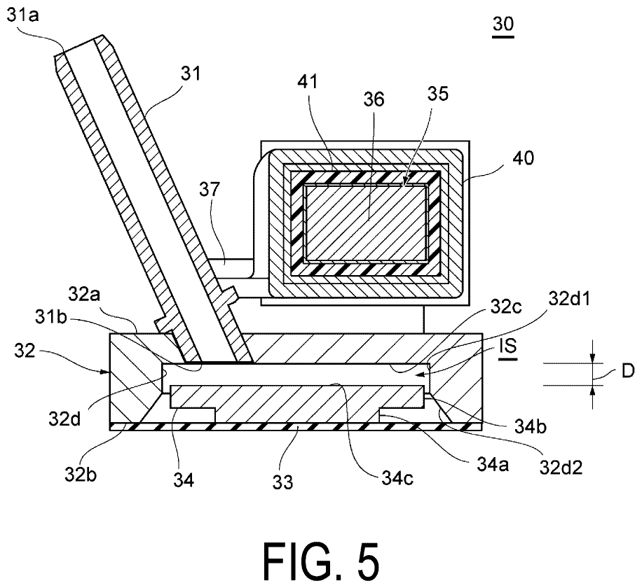

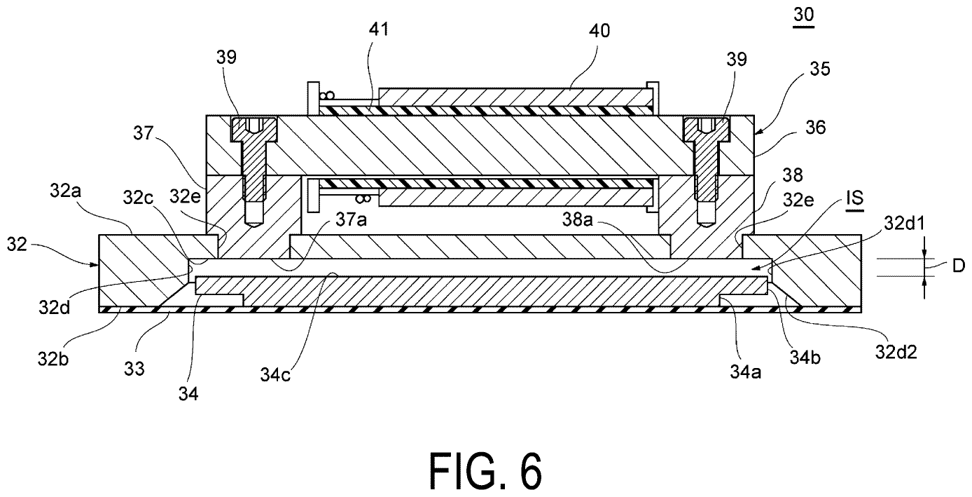

FIG. 4 is a perspective view schematically illustrating a structure of the drive device 30 according to an embodiment. FIG. 5 is a cross-sectional view taken along line 5-5 in FIG. 4, and FIG. 6 is a cross-sectional view taken along line 6-6 in FIG. 4. The drive device 30 is a pump discharging/sucking a fluid from the nozzle 31 by vibration of a vibration plate. Referring to FIGS. 4 to 6 together, the drive device 30 includes a casing 32. The nozzle 31 is attached to the casing 32. The casing 32 has, for example, a flat rectangular parallelepiped outer shape. In this example, the nozzle 31 is attached to an upper surface 32a of the casing 32. The casing 32 has a space (hereinafter referred to as an “interior space”) IS connected to the exterior space ES via the opening 31a at one end of the nozzle 31 (see FIGS. 5 and 6). The interior space IS is a substantially flat rectangular parallelepiped space. The interior space IS is a space filled with a fluid. The nozzle 31 is connected to the interior space IS at an opening 31b at the other end opposite to the opening 31a. The opening 31a and the opening 31b are open to the exterior space ES and the interior space IS.

As is clear from FIGS. 5 and 6, the interior space IS is open at a lower surface 32b of the casing 32, but this open region is covered and closed by a diaphragm 33. In this example, the contour of the diaphragm 33 matches the contour of the lower surface 32b the casing 32. The diaphragm 33 is attached to the lower surface 32b of the casing 32 around the interior space IS. The diaphragm 33 is formed of, for example, a rubber material such as NBR, HNBR, EPDM, or FKM. A magnetic body 34 is supported at the inner surface of the diaphragm 33. The magnetic body 34 is formed in a flat plate shape from, for example, a rectangular first plate 34a and a second plate 34b continuous with the rectangular first plate 34a and having a larger contour than the contour of the first plate 34a.

The casing 32 defines an inner surface 32c facing away from the upper surface 32a and an inner side surface 32d intersecting the inner surface 32c. The inner surface 32c and the inner side surface 32d define the interior space IS. The magnetic body 34 is accommodated in the interior space IS without contacting the inner surface 32c and the inner side surface 32d. The inner side surface 32d includes a part 32d1 intersecting the inner surface 32c and an inclined part 32d2. The inclined part 32d2 of the inner side surface 32d is continuous with the intersecting part 32d1 of the inner side surface 32d, and has a shape such that the part of the inclined part 32d farther from the magnetic body 34 is farther from the inner surface 32c. An upper surface 34c of the second plate 34b of the magnetic body 34 is opposite the inner surface 32c of the casing 32 in parallel, for example. When the drive device 30 is not energized, a distance D between the upper surface 34c of the magnetic body 34 and the inner surface 32c of the casing 32 is set to a size such that a predetermined gap is formed between the upper surface 34c of the magnetic body 34 and the inner surface 32c of the casing 32 even when the diaphragm 33 is deformed to the maximum.

A yoke 35 is attached to the upper surface 32a of the casing 32. The yoke 35 includes a yoke body 36 and one magnetic pole part or a plurality of (in this example, a pair of) magnetic pole parts 37 and 38 coupled to both ends of the yoke body 36. The yoke 35 is formed of a magnetic body such as iron. In this example, at least a part of the pair of magnetic pole parts 37 and 38 is attached to the through holes 32e and 32e formed at the upper surface 32a of the casing 32, respectively. In this way, each of lower end surfaces 37a and 38a of the magnetic pole parts 37 and 38 is opposed to the upper surface 34c of the magnetic body 34 in the interior space IS. In this example, the lower end surfaces 37a and the 38a are defined to be flush with the inner surface 32c of the casing 32. Note that the yoke body 36 and the magnetic pole parts 37 and 38 are coupled to each other by fastening components 39 such as screws.

The yoke body 36 is supported by the pair of magnetic pole parts 37 and 38, and is thereby disposed along the upper surface 32a of the casing 32. A part of the yoke body 36 is surrounded by the coil 40. In other words, the coil 40 surrounds a part of the yoke body 36 and is wound around the part of the yoke body 36. In this example, the coil 40 is wound around a part of the yoke body 36 around an axial line along the longitudinal direction of the yoke body 36. Note that an insulator 41 is interposed between the yoke body 36 and the coil 40. The insulator 41 is formed of an insulating material. The coil 40 can be supplied with current from an external power supply. The yoke 35 is covered with the diaphragm 33 and the magnetic body 34 in a plan view. That is, in a plan view, the contour of the yoke 35 is disposed inside the contours of the diaphragm 33 and the magnetic body 34. Note that the magnetic body 34 forms a part of the vibrator, while the yoke 35 forms a part of the stator (stationary part). The vibrator can vibrate in a direction approaching the magnetic pole parts 37 and 38 and a direction away from the magnetic pole parts 37 and 38. A part (space) of the interior space IS is formed between the yoke 35 and the vibrator, and the second opening 15 of the display device 10 is connected to the part of the interior space IS via the nozzle 31.

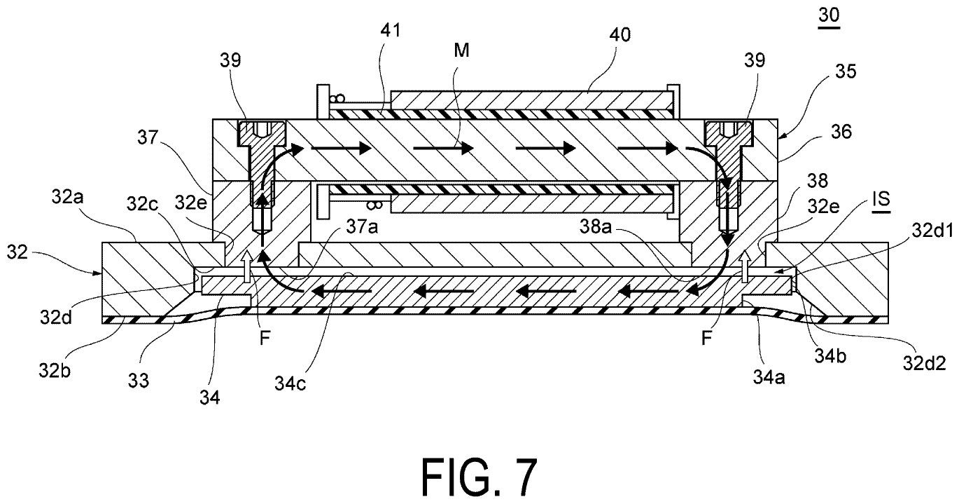

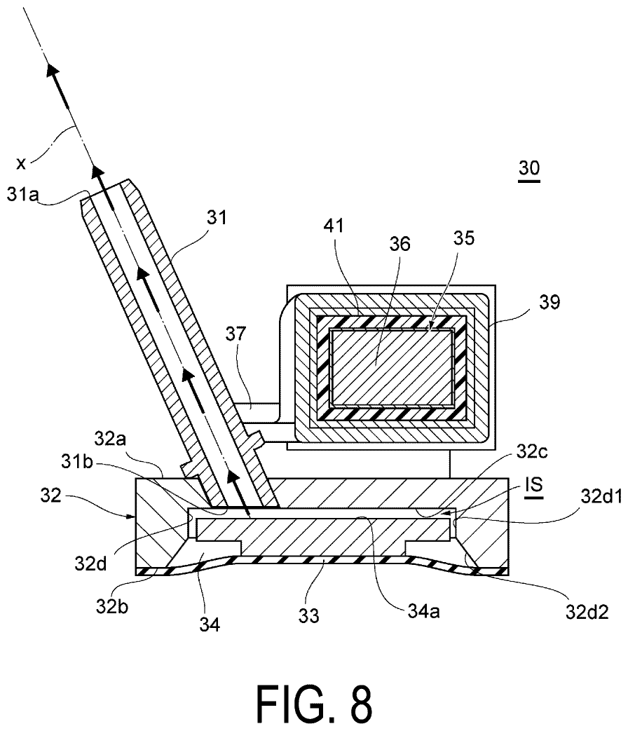

Here, a case where the drive device 30 operates will be described. FIG. 7 is a cross-sectional view of the drive device 30 when a current is supplied to the coil 40, corresponding to FIG. 6. FIG. 8 is a cross-sectional view of the drive device 30 when a current is supplied to the coil 40, corresponding to FIG. 5. When the coil 40 is supplied with current, that is, when the drive device 30 is energized, the yoke 35 is excited to generate a magnetic field. For example, one of the magnetic pole parts 37 and 38 of the yoke 35 is the N pole, and the other is the S pole. As a result, a magnetic circuit indicated by a flow M of magnetic flux in FIG. 7 is formed between the yoke 35 and the magnetic body 34. Specifically, the flow M of the magnetic flux flows from the yoke body 36 to one end of the magnetic body 34 through the magnetic pole part 38, and then returns from the other end of the magnetic body 34 to the yoke body 36 through the magnetic pole part 37.

As a result, the magnetic pole parts 37 and 38 of the yoke 35 generate an attraction force F attracting the magnetic body 34 based on the principle of an electromagnetic solenoid. The magnetic body 34 is displaced in a direction F toward the yoke 35 and approaching the magnetic pole parts 37 and 38 based on the elastic deformation of the diaphragm 33 by the attraction force F. As described above, the distance D between the upper surface 34c of the magnetic body 34 and the inner surface 32c of the casing 32 is set to a size such that the upper surface 34c of the magnetic body 34 does not come into contact with the inner surface 32c of the casing 32 even when the diaphragm 33 is deformed to the maximum. Therefore, even when the magnetic body 34 is displaced to the maximum in the direction F, a predetermined gap is present between the upper surface 34c of the magnetic body 34 and the inner surface 32c of the casing 32. The fluid (air) in the interior space IS is compressed between the upper surface 34c of the magnetic body 34 and the inner surface 32c of the casing 32 by the displacement of the magnetic body 34. As a result, as indicated by the arrow in FIG. 8, the fluid is discharged from the opening 31a of the nozzle 31 to the exterior space ES.

On the other hand, when the current to the coil 40 is stopped, that is, when the energization to the drive device 30 is stopped, the magnetic field decreases in the yoke 35, and the attraction force F also decreases. As a result, the diaphragm 33 tends to return to the original shape by the restoring force due to the elastic force of the diaphragm 33. When the diaphragm 33 returns to the original shape, the magnetic body 34 is displaced to the original position in a direction away from the magnetic pole parts 37 and 38. As the diaphragm 33 returns to the original shape, the interior space IS is opened between the upper surface 34c of the magnetic body 34 and the inner surface 32c of the casing 32, and the fluid (air) in the interior space IS expands into a part of the opened interior space IS. The fluid is sucked into a part of the interior space IS opened from the opening 31a of the nozzle 31, and the fluid is sucked into the drive device 30 from the opening 31a of the nozzle 31. In this way, the supply and stop of the current to the coil 40 are repeated at a predetermined frequency, and thus the magnetic body 34 vibrates by repeating moving close to the magnetic pole parts 37 and 38 and moving away from the magnetic pole parts 37 and 38. That is, the magnetic body 34 forms a vibrator. In this way, the fluid is repeatedly discharged and sucked through the opening 31a of the nozzle 31. The drive device 30 pulsates. As a result, the fluid is discharged from the nozzle 31, and vibration of the fluid (hereinafter, referred to as “fluid vibration”) can be provided in accordance with the repetition of the discharge of the fluid.

Next, a situation where the electronic device 1 is used will be described. In the electronic device 1, the display unit 14 displays the object O in the exterior space ES adjacent to the side surface 12 of the display device 10 (see FIG. 2). At this time, when the user places his/her finger at the position of or in the vicinity of the object O, the sensor 21 detects the finger, that is, the target, at the position of or in the vicinity of the object O. The drive device 30 is operated in accordance with the detection of the sensor 21. Specifically, as described above, the drive device 30 is repeatedly energized and de-energized, and thus the fluid is repeatedly discharged and sucked through the opening 31a of the nozzle 31. The fluid vibration caused by the discharge and suction of the fluid is transmitted to the object O, that is, the finger while the nozzle 31 is directed to the finger. In this way, a stimulation giving a pseudo tactile sense is provided to the finger.

In the electronic device 1 as described above, when the sensor 21 detects the object O or a target in the vicinity of the object O, that is, the finger of the user, a stimulation is provided to the user by the fluid vibration discharged from the nozzle 31. This stimulation is provided from the opening 31a of the single nozzle 31 connected to the interior space IS. In this way, the pump is realized by the vibration of the magnetic body 34 by the magnetic circuit. Note that the space and the valve structure necessary for the exhaust and the intake may not be provided. In the present embodiment, provided that the opening 31a is one opening, the other opening 31b of the nozzle 31 connected to the interior space IS is an opening open to the exterior space ES and the interior space IS. Therefore, the openings 31a and 31b of the nozzle 31 connect the exterior space ES and the interior space IS, and allow the fluid to freely flow in and out. The drive device 30 is realized by a simple configuration. Such a configuration with a small number of components can be downsized. That is, according to the present invention, it is possible to provide the electronic device 1 capable of being reduced in size with a simple configuration.

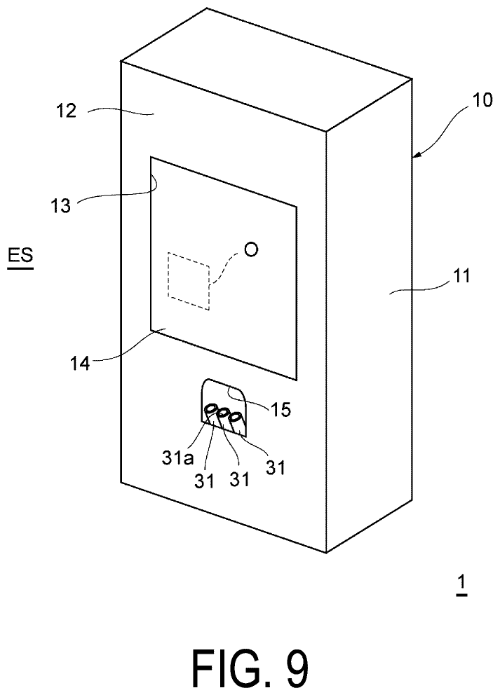

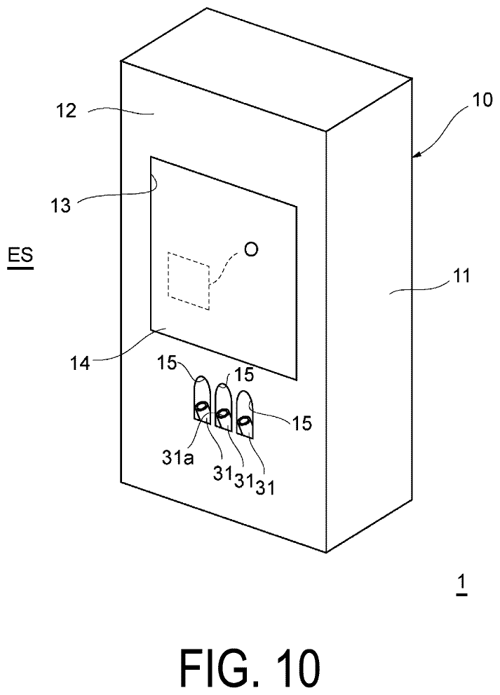

Note that, in the above embodiment, the object O is, for example, a button, and the single nozzle 31 is disposed at the second opening 15 of the display device 10, but a plurality of (three in this example) nozzles 31 may be disposed in the single second opening 15, for example, as illustrated in FIG. 9. For example, when the object O is a group of a plurality of buttons for inputting numbers of 0 to 9, the nozzles 31 of the number corresponding to the number of buttons may be disposed. In this case, the fluid vibration may be provided to the buttons of all the numbers no matter which number is input. By adding a valve to each nozzle 31, only the nozzle 31 corresponding to the position of the button input by the user may provide the fluid vibration. Note that, for example, as illustrated in FIG. 10, the display device 10 may include a plurality of second openings 15, and the nozzle 31 may be disposed in each of the plurality of second openings 15. Instead of the plurality of nozzles 31, the single nozzle 31 may include a plurality of openings.

In the above embodiment, the drive device 30 is operated based on the principle of an electromagnetic solenoid, but may be operated based on the principle of a motor having a tubular coil. Specifically, a flat plate-shaped permanent magnet is used for the vibrator instead of the magnetic body 34. In this case, when a current is supplied to the coil 40, the yoke 35 is excited to generate a magnetic field in the same manner as described above. The magnetic pole parts 37, 38 of the yoke 35 generate an attraction force F attracting the permanent magnet. On the other hand, when the direction of the current to the coil 40 is switched to the opposite direction, the magnetic pole parts 37 and 38 of the yoke 35 generate a repulsive force to move the permanent magnet away. In this way, by switching the direction of the current supplied to the coil 40, the fluid vibration is discharged from the opening 31a of the nozzle 31 in the same manner as described above.

Although the present invention has been described through the above embodiments, the technical scope of the present invention is not limited to the scope described in the above embodiments. Various modifications or improvements can be made to the above embodiments, and this is obvious to a person having skill in the art. Such modified or improved form is also included in the technical scope of the present invention, and this is obvious from the description of the claims.

The above-described embodiments are intended to facilitate understanding of the present invention and are not intended to be construed as limiting. The components included in the above-described embodiments, arrangement, materials, conditions, shapes, sizes, or the like, of the components are not limited to those exemplified and may be appropriately changed. The components illustrated in the different embodiments can be replaced or combined partially to the extent not technically inconsistent.

### REFERENCE SIGNS LIST

1 Electronic device, 10 Display device, 11 Housing, 12 Side surface, 13 First opening (opening), 14 Display unit, 15 Second opening (opening), 16 Light source, 17 Light guide plate, 17a Light incident side surface, 17b Non-display surface side, 17c Refraction part, 17d Display surface side, 18 Retroreflective sheet, 19 Half mirror, 20 Top cover, 21 Sensor, 30 Drive device (stimulation device), 31 Nozzle, 31a Opening, 31b Opening, 32 Casing, 32a Upper surface, 32b Lower surface, 32c Inner surface, 32d Inner side surface, 32d1 Intersecting part, 32d2 Inclined part, 32e Through hole, 33 Diaphragm, 34 Magnetic body (vibration plate), 34a First plate, 34b Second plate, 34c Upper surface, 35 Yoke, 36 Yoke body, 37 Magnetic pole part, 37a Lower end surface, 38 Magnetic pole part, 38a Lower end surface, 39 Fastening component, 40 Coil, 41 Insulator, D Distance, ES Space (exterior space), F Attraction force, IS Space (interior space), L1 Path, L2 Path, L3 Path, M Flow of magnetic flux, O Object, X Central axis line

1. A stimulation device comprising:
a casing including an opening and a space connected to an outside via the opening;
a diaphragm;
a magnetic body supported by the diaphragm;
a magnetic body covered with the diaphragm; and
a coil,
wherein a fluid is discharged from the space to the outside via the opening.

2. The stimulation device according to claim 1,
wherein a fluid is sucked into the space from the outside via the opening.

3. The stimulation device according to claim 1,
wherein the casing includes the opening or a plurality of openings including the opening.

4. The stimulation device according to claim 1,
wherein the coil surrounds a part of the magnetic body covered with the diaphragm, and
the magnetic body supported by the diaphragm is a vibrator.

5. The stimulation device according to claim 4,
wherein the magnetic body covered with the diaphragm includes one magnetic pole part or a plurality of magnetic pole parts opposed to the vibrator, and
the vibrator is configured to vibrate in a direction approaching the magnetic pole part and a direction away from the magnetic pole part.

6. The stimulation device according to claim 1,
wherein the space is present between the magnetic body covered with the diaphragm and the magnetic body supported by the diaphragm.

7. An electronic device comprising:
a display device including a side surface;
a sensor; and
a drive device,
wherein the display device displays an object at a space adjacent to the side surface,
an opening is formed at the side surface of the display device, and
the drive device discharges a fluid from the opening toward the object.

8. The electronic device according to claim 7,
wherein the drive device is a pump.

9. The electronic device according to claim 8,
wherein a fluid is sucked into the drive device from the opening.

10. The electronic device according to claim 9,
wherein the drive device includes a single nozzle or a plurality of nozzles disposed in the opening and a space filled with the fluid, and
the space is connected to the opening via the nozzle.

11. The electronic device according to claim 7,
wherein the sensor detects a target at a position of the object or near the object.

12. The electronic device according to claim 7,
wherein a stimulation is provided to the target at the position of the object or near the object by the fluid discharged from the opening toward the object.

13. The electronic device according to claim 7,
wherein the drive device includes a diaphragm and a vibrator supported by the diaphragm.

14. The electronic device according to claim 13,
wherein the drive device includes a yoke covered with the diaphragm, and a coil.

15. The electronic device according to claim 14,
wherein the coil surrounds a part of the yoke, and
the vibrator is formed of a magnetic body.

16. The electronic device according to claim 14,
wherein the yoke includes one magnetic pole part or a plurality of magnetic pole parts opposed to the vibrator, and
the vibrator is configured to vibrate in a direction approaching the magnetic pole part and in a direction away from the magnetic pole part.

17. The electronic device according to claim 14,
wherein a space is formed between the yoke and the vibrator, and
the opening is connected to the space.
